(19) United States
(12) Patent Application Publication
(10) Pub. No.: US 2010/0287502 A1
(43) Pub. Date: Nov. 11, 2010

(54) IMAGE SEARCH DEVICE AND IMAGE SEARCH METHOD

(75) Inventors: Kensei Ito, Tokyo (JP); Takashi Fujii, Tokorozawa-shi (JP)

Correspondence Address: VOLPE AND KOENIG, P.C., UNITED PLAZA, 30 SOUTH 17TH STREET, PHILADELPHIA, PA, 19103, US

(73) Assignee: Olympus Imaging Corp., Tokyo (JP)

(21) Appl. No.: 12/769,233

(22) Filed: Apr. 28, 2010

(30) Foreign Application Priority Data
May 11, 2009 (JP) 2009114544

(51) Int. Cl. G06F 3/048

(52) U.S. Cl. 715/810

(57) ABSTRACT

An image search device includes a target-image selecting unit that selects target image data from recorded image data; a target-image displaying unit that displays the selected target-image data on a display unit; a relevant-image selecting unit that selects relevant image data that contains a predetermined number of images each having at least one element item identical to the corresponding piece of element information assigned to the target image data in such a manner that the relevant image data contains at least one image that has combination of the element items that is different from combination of the element items assigned to the other relevant images; and a relevant-image displaying unit that displays, on the display unit, the selected relevant image data containing the predetermined number of the images.

### CROSS-REFERENCE TO RELATED APPLICATIONS

This application is based upon and claims the benefit of priority from Japanese Patent Application No. 2009-114544, filed on May 11, 2009, the entire contents of which are incorporated herein by reference.

### BACKGROUND OF THE INVENTION

1. Field of the Invention

The present invention relates to an image search device and an image search method.

2. Description of the Related Art

Most modern digital cameras have large memory capacities that can store one thousand or more images so that the user can take images without worrying about the memory capacity. However, with the increase in the number of images storable in digital cameras, the user has to handle too many images during playback, which may increase the time taken to find a desired image amongst the taken images. Therefore, an efficient image search is needed.

### SUMMARY OF THE INVENTION

An image search device according to an aspect of the present invention includes an image storage unit that stores therein a plurality of pieces of image data; an element-information storage unit that stores therein a plurality of pieces of element information indicative of element items assigned respectively to the pieces of the image data stored in the image storage unit; a target-image selecting unit that selects target image data from the image data stored in the image storage unit; a target-image displaying unit that displays the target image data selected by the target-image selecting unit on a display unit; a relevant-image selecting unit that selects a predetermined number of pieces of relevant image data that contain at least one of the pieces of element information identical to the piece of element information assigned to the target image data in such a manner that the predetermined number of pieces of relevant image data contain at least one image that has a different combination of the pieces of element information; and a relevant-image displaying unit that displays, on the display unit, the predetermined number of pieces of relevant image data selected by the relevant-image selecting unit.

An image search method according to another aspect of the present invention includes selecting target image data from image data stored; displaying the selected target image data; selecting, on the basis of a plurality of pieces of element information indicative of element items assigned respectively to the pieces of the image data, a predetermined number of pieces of relevant image data that contain at least one of the pieces of element information identical to the piece of element information assigned to the target image data in such a manner that the predetermined number of pieces of relevant image data contain at least one image that has a different combination of the pieces of element information; and displaying the predetermined number of pieces of relevant image data selected.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a digital camera viewed from the front side;

FIG. 2 is a perspective view of the digital camera viewed from the rear side;

FIG. 3 is a block diagram of the configuration of the digital camera;

FIG. 4 is a schematic view of an image search screen;

FIG. 5 is a schematic diagram of a target-image display screen according to a first embodiment;

FIG. 6 is a schematic diagram of pieces of element information;

FIG. 7 is a schematic diagram that explains how a group of relevant images is made according to the first embodiment;

FIG. 8 is a flowchart of a process performed by the digital camera according to the first embodiment;

FIG. 9 is a detailed flowchart of an on-screen relevant image setting process according to the first embodiment;

FIG. 10 is a continuation of the flowchart shown in FIG. 8;

FIG. 11 is a detailed flowchart of a log display process;

FIG. 12 is a schematic diagram that explains how images are set as on-screen relevant images according to a second embodiment;

FIG. 13 is a flowchart of a process performed by a digital camera according to the second embodiment;

FIG. 14 is a detailed flowchart of an on-screen relevant image setting process according to the second embodiment;

FIG. 15 is a continuation of the flowchart shown in FIG. 13;

FIG. 16 is a schematic diagram of a target-image display screen according to a third embodiment;

FIG. 17 is a schematic diagram that explains how images are set as on-screen relevant images according to the third embodiment;

FIG. 18 is a flowchart of a process performed by a digital camera according to the third embodiment;

FIG. 19 is a detailed flowchart of an on-screen relevant image setting process according to the third embodiment;

FIG. 20 is a continuation of the flowchart shown in FIG. 18;

FIG. 21 is a schematic diagram of a target-image display screen according to a fourth embodiment; and

FIG. 22 is a detailed flowchart of an on-screen relevant image setting process according to the fourth embodiment.

### DETAILED DESCRIPTION OF THE PREFERRED EMBODIMENTS

Exemplary embodiments of the present invention are described in detail below with reference to the accompanying drawings. In the present embodiment, a digital camera is used as an image search device according to the present invention. It is noted that the present invention is not limited to these embodiments. The same parts are denoted with the same reference numerals in the drawings.

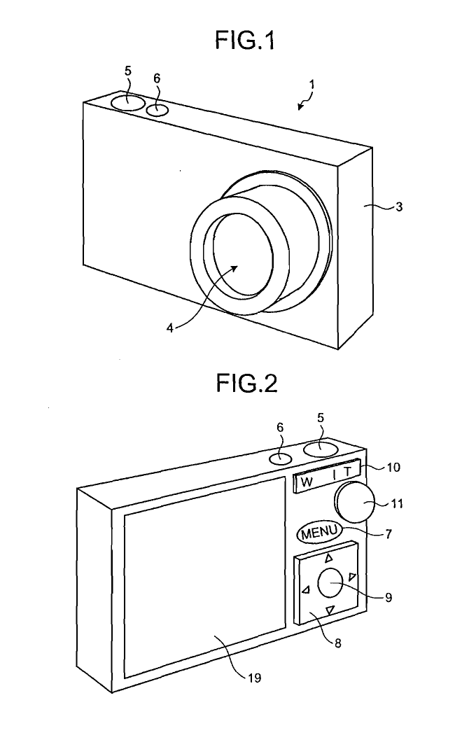

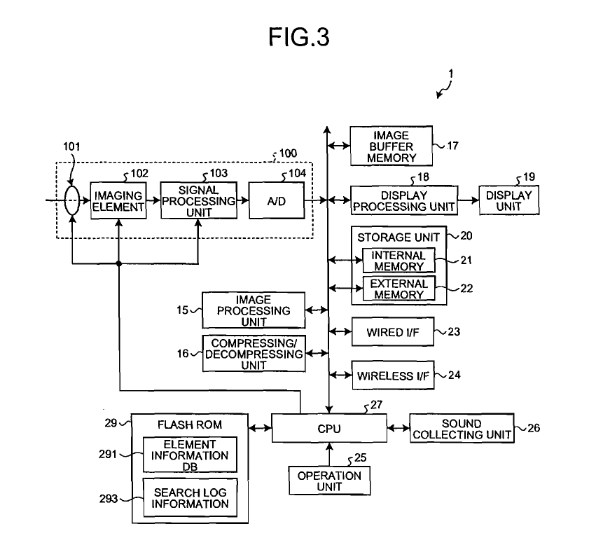

FIG. 1 is a perspective view of a digital camera 1 viewed from the front side. FIG. 2 is a perspective view of the digital camera 1 viewed from the rear side. As shown in FIG. 1, the digital camera 1 includes an imaging lens 4 attached on the front surface of a main body 3; and an imaging unit 100 (see FIG. 3), inside the main body 3, that takes an image of a subject by light coming through the imaging lens 4. On the upper surface of the main body 3, a release button 5 that is used to instruct the time to take an image and a power ON/OFF button 6 are arranged.

On the rear surface of the main body 3, as shown in FIG. 2, operation members, such as a display unit 19 that displays various screens, a menu button 7, an arrow pad 8, an enter button 9, a zoom button (TW button) 10, a mode dial 11, are arranged. The arrow pad 8 is a button to indicate the directions, i.e., up, down, right, and left. The enter button 9 is a button to enter instructions or the like. The zoom button (TW button) 10 works as a zoom button during the shooting mode and changes the magnitude of an image to be taken. The zoom button 10, in contrast, works as a display-mode switching button during the playback mode and switches, for example, between a close-up view and a close-down view of an image. The mode dial 11 is a dial to switch, for example, between operation modes of the digital camera 1.

On the side surface of the main body 3, a card slot (not shown) is provided to connect the digital camera 1 to a portable recording medium (an external memory 22 shown in FIG. 3). On the side surface of the main body 3, a connector (not shown) that includes a data input terminal is provided to connect the digital camera 1 to an external device via a communication cable. The connector is compatible with, for example, universal serial bus (USE) standards. The connector is used to connect the digital camera 1 to an external device, such as a personal computer (PC), and transfer image data to the external device.

When the digital camera 1 is powered on by operation of the power ON/OFF button 6 and the operation mode is switched to the shooting mode by operation of the mode dial 11, the digital camera 1 is ready to take an image. In the shooting mode, images of the subject by light coming through the imaging lens 4 are displayed one frame to another (each, for example, 1/30 second) on the display unit 19 in real time as live preview images. The shooting mode includes various modes, such as a normal shooting mode, a sports-game mode, a landscape mode for a landscape, a portrait mode, and a continuous shooting mode in which images of the subject are taken continuously for a short time. The user dials the mode dial 11 and selects a shooting mode according to the shooting scene. While checking the live preview images, the user presses the release button 5 and takes a still image or video images. During the power is ON, the user can switch the operation mode to the playback mode by dialing the mode dial 11 and enjoy the images taken by the digital camera 1 being displayed (replayed) on the display unit 19. When the user switches the operation mode to the search mode by dialing the mode dial 11, the user can search for a desired one amongst the images taken at a previous time and display the desired image.

The configuration of the digital camera 1 is described below. FIG. 3 is a block diagram of the configuration of the digital camera 1. As shown in FIG. 3, the digital camera 1 includes an imaging optical system 101, an imaging element 102, a signal processing unit 103, an A/D conversion circuit 104, an image processing unit 15, a compressing/decompressing unit 16, an image buffer memory 17, a displaying unit 18, the display unit 19, a storage unit 20, a wired interface (I/F) 23, a wireless I/F 24, an operation unit 25, a sound collecting unit 26, a CPU 27, a flash ROM 29, etc. The CPU 27 works as a target-image selecting unit, a target-image displaying unit, a relevant-image selecting unit, a relevant-image displaying unit, a target-image log displaying unit, and a display-mode switching unit. In the digital camera 1, the imaging optical system 101, the imaging element 102, the signal processing unit 103, the A/D conversion circuit 104, etc., constitute the imaging unit 100.

The imaging optical system 101 includes the imaging lens 4 (see FIG. 1), a diaphragm, a shutter, etc., and forms a subject image on the imaging element 102. The imaging element 102 is a solid-state image sensor, such as a charge coupled device (CCD) image sensor or a complementary metal oxide semiconductor (CMOS) image sensor. The imaging element 102 receives light reflected from a subject via the imaging optical system 101, converts the light to electricity, and outputs an analog electric signal. Upon receiving the analog electric signal from the imaging element 102, the signal processing unit 103 processes the analog electric signal using correlated double sampling (CDS), automatic gain control (AGC), etc. Upon receiving the processed analog electric signal from the signal processing unit 103, the A/D conversion circuit 104 converts the analog electric signal to a digital electric signal and thus the image data is created.

When, for example, the image data output from the A/D conversion circuit 104 is displayed on the display unit 19 as a frame to be displayed, the image buffer memory 17 stores therein the image data before the displaying. When data containing a taken image is read from the storage unit 20 (an internal memory 21 or the external memory 22) and then displayed on the display unit 19, the image buffer memory 17 stores therein the read image data before the displaying. When data containing a taken image output from the A/D conversion circuit 104 is stored in the storage unit 20, the image buffer memory 17 stores therein the image data before the storing.

Upon receiving the image data from the imaging unit 100, the image processing unit 15 processes the image data using various techniques and converts the processed image data into image data suitable for the storing or the displaying. For example, the image processing unit 15 converts a taken image into a small-size image for display (thumbnail), thereby creating data containing the thumbnail (thumbnail data).

The image processing unit 15 extracts feature information from data containing a taken image. For example, the image processing unit 15 extracts the feature information using a face detection technology disclosed in, for example, U.S. Pat. No. 7,324,670. During the face detection process, a region of a face (face region) is detected in the image data using, for example, pattern matching, and various facial parts, such as the right and left eyes, the nose, the lips, etc., are detected in the image data according to the result of the face region detection. The image processing unit 15 according to the first embodiment performs the face detection process and, for example, counts the detected faces in accordance with the result of the face detection. The number of the detected faces is set as the feature information. The image processing unit 15 counts the detected faces and extracts the number of the faces as the feature information. The image processing unit 15 recognizes the landscape (background) in accordance with a result of the image processing, detects a mountain, a river, a sea, a building, etc., in the image, and extracts them as the feature information.

When data containing a taken image is stored in the storage unit 20, the compressing/decompressing unit 16 compresses the data using, for example, JPEG (joint photo graphic experts group). When the image data is read from the storage unit 20 and then displayed on the display unit 19, the compressing/decompressing unit 16 decompresses the image data.

The displaying unit 18 displays the image data to be displayed on the display unit 19. For example, if the shooting mode is selected, the displaying unit 18 displays, continuously on the display unit 19 as live preview images, images that have been taken frame by frame by the imaging element 102 and then subjected to the image processing by the image processing unit 15. If the playback mode is selected, the displaying unit 18 displays, on the display unit 19, an image that have been read from the storage unit 20 and then subjected to the image processing by the image processing unit 15. The display unit 19 displays thereon not only taken images and live view images but also setting screens that contain various setting information about the digital camera 1. The display unit 19 is, for example, a TFT LCD.

The wireless I/F 24 is an interface that connects the digital camera 1 to an external device so that image data is wirelessly transferred between them. The wireless I/F 24 is an interface compatible with transmission standards, for example, wireless USB (WUSB), ultra wideband (UWB) wireless transmission, optical wireless transmission based on Infrared Data Association (IrDA) specifications, etc.

The wired I/F 23 is an interface that connects the digital camera 1 to an external device so that image data is transferred between them via a communication cable. The wired I/F 23 is an interface compatible with, for example, USB standards and IEEE1394 standards.

The storage unit 20 includes the internal memory 21 and the external memory 22. The internal memory 21 and the external memory 22 is made up of a recording medium and a reading/writing device that reads/writes from/to the recording medium, etc. The recording medium can be, for example, semiconductor memories, such as an updatable flash memory and a ROM, an internal hard disk or an external hard disk connected to the digital camera 1 via a data communication terminal, and a memory card. The internal memory 21 and the external memory 22 are one or a combination of recording media that are selected as appropriately from the above-described types. The storage unit 20 works as an image storage unit, i.e., stores therein data containing images taken by the imaging unit 100. The storage unit 20 stores therein not only the image data but also sound data that is collected by the sound collecting unit 26 during the time of, for example, shooting.

The operation unit 25 receives various user instructions, such as an instruction for time to take an image, an instruction to switch the operation modes that include, shooting modes, a playback mode, and a search mode, and an instruction to set shooting configurations, and sends a signal of the instruction to the CPU 27. The operation unit 25 is made up of, for example, button switches each assigned to a function, dials, and sensors. The operation unit 25 includes the release button 5, the power ON/OFF button 6 shown in FIGS. 1 and 2, the menu button 7, the arrow pad 8, the enter button 9, the zoom button 10, and the mode dial 11 shown in FIG. 2.

The sound collecting unit 26 is a sound collector (microphone) that collects sounds or voices of the subject and outputs a signal of the collected sounds to the CPU 27.

The CPU 27 reads a camera program from the flash ROM 29 in accordance with, for example, the instruction signal received from the operation unit 25, executes the read program, and sends instructions or data to the target unites of the digital camera 1, thereby controlling the operation of the digital camera 1. For example, the CPU 27 performs a process for causing the imaging optical system 101 to AF control or zoom control and a process for causing the imaging unit 100 to create data containing a taken image. The CPU 27 assigns image numbers to the taken images in chronological shooting order and stores the created image data in the storage unit 20 in associated with the image number or information indicative of the shooting time (shooting date and time). The CPU 27 performs a process for assigning element information to an taken image and storing the taken image and the element information in an element information database (DB) 291 of the flash ROM 29 and a process for, when an taken image is displayed as a target image on a screen, setting the image number of the target image as target-image log information 293. The CPU 27 performs a process for creating sound data from the sound signal collected by the sound collecting unit 26, a process for storing the created sound data, a process for setting various shooting conditions, and a process for displaying image data on the display unit 19. Moreover, the CPU 27 performs a process for outputting the sound data from a speaker (not shown), a process for inputting/outputting data via the wired I/F 23 or the wireless I/F 24, a process for controlling various operations of the digital camera 1, and a process for implementing various functions of the digital camera 1.

The flash ROM 29 is an electrically erasable nonvolatile memory and stores therein various camera programs and data used in the camera programs. The camera programs are used to activate the digital camera 1 and implement various functions of the digital camera 1. The flash ROM 29 works as an element-information storage unit, i.e., stores therein the element information DB 291. The element information DB 291 contains element information assigned to every taken image stored in the storage unit 20.

In the first embodiment, during creation of a taken image, four element items are assigned to the taken image that include shooting date, shooting mode, presence/absence of human figures (hereinafter, “No. of human figures”), type of the subject (hereinafter, “subject type” in short). The element items are expressed by values (element information). For example, the CPU 27 extracts the shooting date from the shooting date and time and sets the extracted shooting date as the element item “shooting date”. The CPU 27 sets the shooting mode in which the image is taken selected from the above-described shooting modes that include the normal shooting mode, the sports-game mode, the landscape mode, and the portrait mode, as the element item “shooting mode”. The CPU 27 sets the feature information extracted by the image processing unit 15 as the “No. of human figures” or the “subject type”. For example, the CPU 27 sets the number of faces detected in the image data as the element item “No. of human figures” in accordance with a result of the face detection process performed by the image processing unit 15. Moreover, the CPU 27 sets the type of the landscape as the element item “subject type” on the basis of the landscape recognized/detected by the image processing unit 15 in the image data.

The flash ROM 29 works as a target-image log storage unit, i.e., stores therein the target-image log information 293 and manages logs of images that are set as the target image in the search mode. For example, the target-image log information 293 contains the image numbers of images that have been displayed on a screen as the target image in the search mode arranged in chronological search order.

The search mode, which is a motion mode of the digital camera 1, is described below.

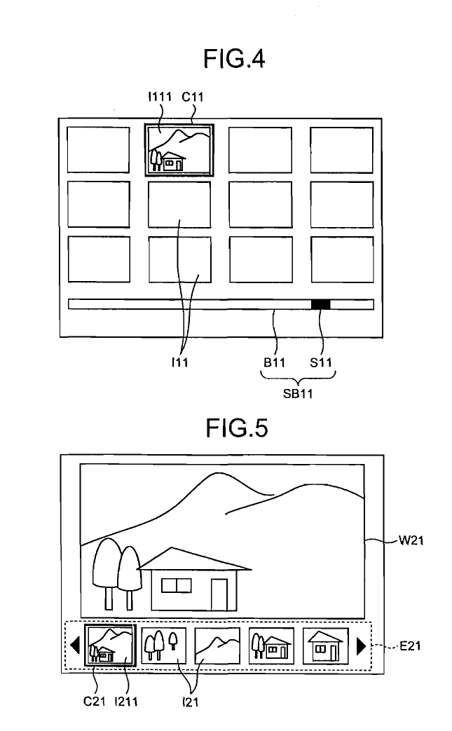

FIG. 4 is a schematic view of an image search screen appearing on the display unit 19 when the search mode is turned on by operation of the mode dial 11. On the image search screen, as shown FIG. 4, image data to be played back are displayed in the thumbnail-size images. In the example, all the image data stored in the storage unit 20 are set as images to be played back, and the images are displayed on the image search screen as a list of thumbnails I11 arranged in chronological shooting order. A shooting-span indicator bar SB11 is displayed in the lower part of the image search screen. The shooting-span indicator bar SB11 is made up of a bar B11 and a slider S11 that occupies a part of the bar B11. The length of the bar B11 indicates the total shooting span of image data stored in the storage unit 20. The slider S11 indicates the temporal range of the image data that is displayed in the thumbnail-size images with respect to the total shooting span. The total shooting span is defined by information about the earliest shooting date and time and the latest shooting date and time.

While checking the image search screen, the user moves a cursor C11 to a desired thumbnail by operation of the arrow pad 8 and then presses the enter button 9, thereby selecting the desired image. For example, if the user presses the enter button 9 in the situation as shown in FIG. 4, the image indicated by a thumbnail I111 is selected as the target image.

FIG. 5 is a schematic diagram of a target-image display screen appearing on the display unit 19 when the target image is selected in the first embodiment. As shown in FIG. 5, the target-image display screen includes a target-image display area W21 at the center where the target image that is selected from the image search screen is displayed. The target-image display screen includes a relevant-image display area E21 under the target-image display area W21. Images relevant to the target image are selected as relevant images from data containing all the taken images stored in the storage unit 20. Images to be displayed are then selected from the relevant images as on-screen relevant images. Data containing the on-screen relevant images are displayed on the relevant-image display area E21 in the thumbnail-size images in such a manner that a set of a predetermined number (e.g., five) of images is displayed at a time beginning with, for example, an image having the earliest shooting date and time. In the example shown in FIG. 5, thumbnails I211 of the on-screen relevant images corresponding to the target image that is selected in the example shown in FIG. 4 are displayed on the left side.

While checking the target-image display screen, the user moves a cursor C21 to a desired thumbnail by operation of the arrow pad 8 and then presses the enter button 9, thereby selecting the desired on-screen relevant image. Suppose the case where the user presses the left arrow of the arrow pad 8 in the situation where the cursor C21 is on a left-most thumbnail I211 in the relevant-image display area E21 (the situation shown in FIG. 5). In this case, a set of five on-screen relevant images having shooting date and time earlier than the shooting date and time of the left-most on-screen relevant image are selected as images to be displayed and the thumbnails of the newly selected on-screen relevant images are displayed on the relevant-image display area E21. If the user presses the right arrow of the arrow pad 8 in the situation where the cursor C21 is on the right-most thumbnail, a set of five on-screen relevant images having shooting date and time later than the shooting date and time of the right-most on-screen relevant image are selected as image to be displayed and the thumbnails of the newly selected images are displayed on the relevant-image display area E21.

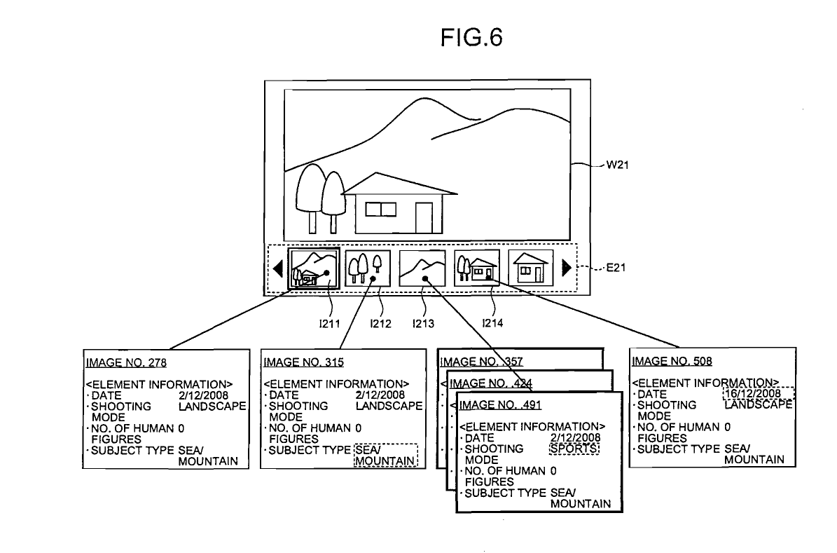

How the on-screen relevant images are selected according to the first embodiment is described below. FIG. 6 is a schematic diagram of thumbnails I211 to I214 of the on-screen relevant images appearing on the relevant-image display area E21 shown in FIG. 5 and the element information assigned to the relevant images from which the on-screen relevant images are selected. As shown in FIG. 6, the thumbnail I211 of the image, which is determined to be both the target image and the on-screen relevant image, has, as the element information, the shooting date “2/12/2008”, the shooting mode “landscape mode”, the No. of human figures “0”, and the subject type “sea/mountain”.

When the target image is selected, in the first embodiment, the process for selecting relevant images from all the taken images stored in the storage unit 20 and selecting on-screen relevant images from the relevant images (hereinafter, “on-screen relevant image setting process”) is performed. During the on-screen relevant image setting process, an image having at least one element item identical to the corresponding piece of the element information assigned to the target image is selected as a relevant image. After that, a group of relevant images is made on the basis of their element information and one image is selected from the group as a representative relevant image.

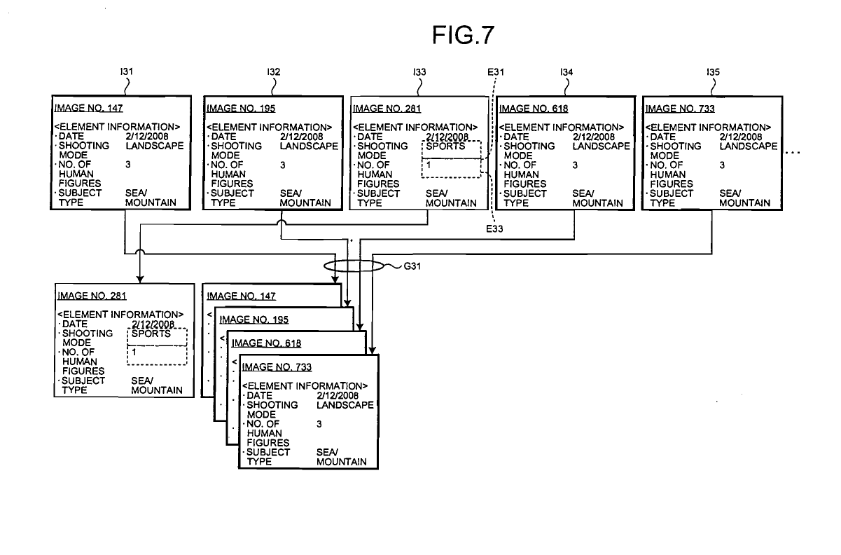

FIG. 7 is a schematic diagram that explains how a group of relevant images is made according to the first embodiment. Relevant images I31 to I35 shown in FIG. 7 correspond to the taken images having the image numbers “147”, “195”, “281”, “618”, and “733”, respectively. The element information assigned to each of the images is shown in FIG. 7. In the first embodiment, as shown in FIG. 7, the relevant images I31, I32, I34, and I35 are selected from the selected relevant images I31 to I35 because they have the combination of the element items identically set (every element item is set identically) and then a group G31 that contains the relevant images I31, I32, I34, and I35 is made. The relevant image I35 is selected from the group of the four relevant images as the representative relevant image because, for example, it has the latest shooting date and time. It is noted that the sequence of the images arranged in chronological shooting order is determined by, for example, information about the shooting date and time stored in the storage unit 20 associated with each image. Alternatively, the sequence of the images arranged in chronological shooting order can be determined by their image numbers. Some other relevant images other than the relevant image having the latest shooting date and time can be selected as the representative relevant image. For example, an image having the earliest shooting date and time can be selected as the representative relevant image. The relevant image I33, in contrast, remains as a solo image that cannot make a group with another image, because element information E31 indicative of the shooting mode and element information E33 indicative of the No. of human figures, both surrounded by the dotted boxes, are different from the shooting mode and the No. of human figures assigned to the four relevant images I31, I32, I34, and I35.

The representative relevant image, which has been selected from the group of the relevant images, the solo relevant image, and the target image are set as the on-screen relevant images.

After that, data containing the images that are set as the on-screen relevant images in the above-described manner are displayed on the relevant-image display area of the target-image display screen in the thumbnail-size images in such a manner that a set of a predetermined number (e.g., five) of images is displayed at a time in chronological shooting order. In the example shown in FIG. 6, the image having the image number “315” (the thumbnail I212) is selected as the on-screen relevant image because every piece of element information is identical to the corresponding piece of element information assigned to the target image having the image number “278”. The images having the image numbers “357”, “424”, and “491” are selected as the relevant images, because all the element items except the shooting mode are identical to the respective element items assigned to the target image. Moreover, a group that contains the images having the image numbers “357”, “424”, and “491” is made, because they have the combination of the element items identically set. The relevant image having the image number “491” is selected as the representative relevant image (the thumbnail I213) because it has the latest shooting date and time.

When the user is looking at an image taken at a previous time, the image may remind the user of images that are relevant to the image, for example, images of the same subject or another subject alike and images taken in almost the same situations. If each element item, such as the “shooting date”, the “No. of human figures”, and the “subject type”, is set to each taken image, it is possible to select the relevant images in the above manner. However, in the case where the relevant images are selected on the basis of the element information assigned to each taken image, if every image having one or more pieces of identical element information is selected as the relevant images, the relevant images may include too many similar images.

In the first embodiment, an image having at least one element item identical to the element item of the target image is selected as a relevant image in the same manner as the above-described conventional technology. In contrast to the conventional manner, if two or more relevant images have the element items each identically set, then a group that contains the relevant images is made and only one image is selected for display from the group. In other words, a predetermined number of (e.g., five in the present embodiment) on-screen relevant images that are displayed on the relevant-image display area of the target-image display screen in the thumbnail-size images are selected in such a manner that not all on-screen relevant images have the combination of the element items identically set.

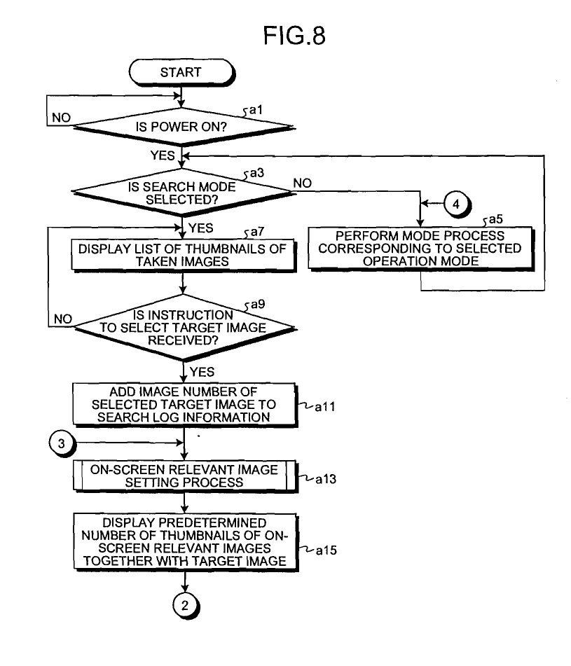

FIG. 8 is a flowchart of a process performed by the digital camera 1 according to the first embodiment. As shown in FIG. 8, when the digital camera 1 is powered on by operation of the power ON/OFF button 6 (Step a1: Yes), the power is supplied to the units of the digital camera 1 and, after the end of the internal-circuit default process or the like, the process control shift to a process corresponding to the selected operation mode. If an operation mode other than the search mode is selected (Step a3: No), the process control shifts to a mode process corresponding to the selected operation mode (Step a5) and then returns to Step a3.

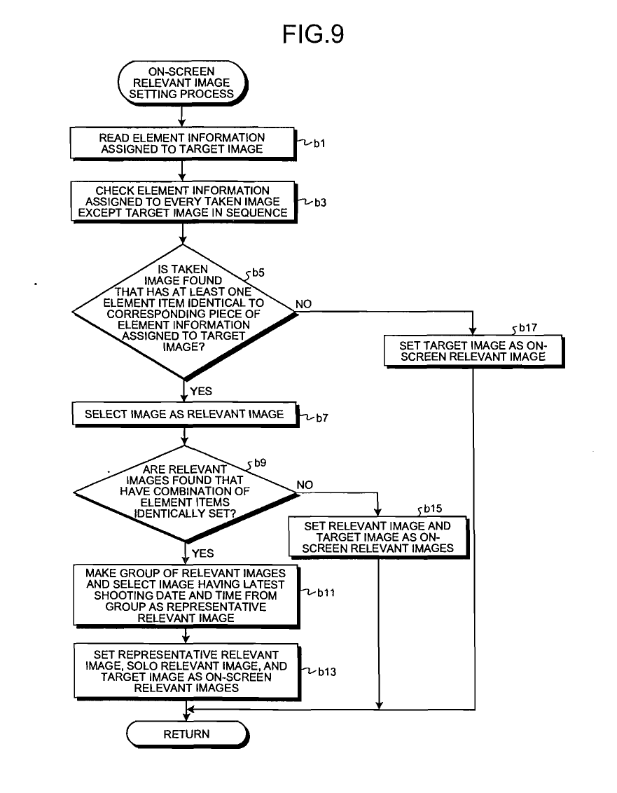

If the search mode is selected as the operation mode (Step a3: Yes), the CPU 27 displays an image search screen on the display unit 19 where a list of a predetermined number of thumbnails of taken images are arranged in the chronological shooting order (Step a7). After that, the CPU 27 receives an instruction to select the target image. When one thumbnail is selected from the list of thumbnails and the instruction to select the target image is received (Step a9: Yes), the CPU 27 adds the image number of the selected target image to the target-image log information 293, thereby updating the target-image log information 293 (Step a11). After that, the CPU 27 performs an on-screen relevant image setting process (Step a13). FIG. 9 is a detailed flowchart of an on-screen relevant image setting process according to the first embodiment.

As shown in FIG. 9, during the on-screen relevant image setting process, the CPU 27 first reads the element information assigned to the target image from the element information DB 291 (Step b1). The CPU 27 then checks the element information assigned to every taken image except for the images stored in the element information DB 291 in sequence (Step b3) and determines whether an image having at least one element item identical to the corresponding piece of the element information assigned to the target image that is read at Step b1 is found. If the determination is positive (Step b5: Yes), the taken image having at least one identical element item is selected as a relevant image (Step b7).

After the relevant images are selected by checking the element information assigned to every taken image except the target image, the CPU 27 determines whether relevant images that have combination of the element items identically set are found. If the determination is positive (Step b9: Yes), the CPU 27 makes a group of these relevant images and sets a relevant image having the latest shooting date and time as the representative relevant image (Step b11). The CPU 27 determines the representative relevant image set at Step b11, the solo relevant image that cannot make a group with another relevant image, and the target image to be the on-screen relevant images (Step b13). After that, the process control returns to Step a13 of FIG. 8 and then goes to Step a15.

If the determination at Step b9 is negative (Step b9: No), the CPU 27 determines the relevant images selected at Step b7 and the target image to be the on-screen relevant images (Step b15). After that, the process control returns to Step a13 of FIG. 8 and then goes to Step a15.

If the determination at Step b5 is negative (Step b5: No), the CPU 27 determines the target image to be the on-screen relevant image (Step b17). After that, the process control returns to Step a13 of FIG. 8 and then goes to Step a15.

At Step a15, the CPU 27 displays the target-image display screen shown in FIG. 5 on the display unit 19 in such a manner that the target image appears on the target-image display area at the center and a predetermined number of (e.g., five) thumbnail-size relevant images appear on the relevant-image display area arranged in chronological shooting order beginning with, for example, an image having the earliest shooting date and time.

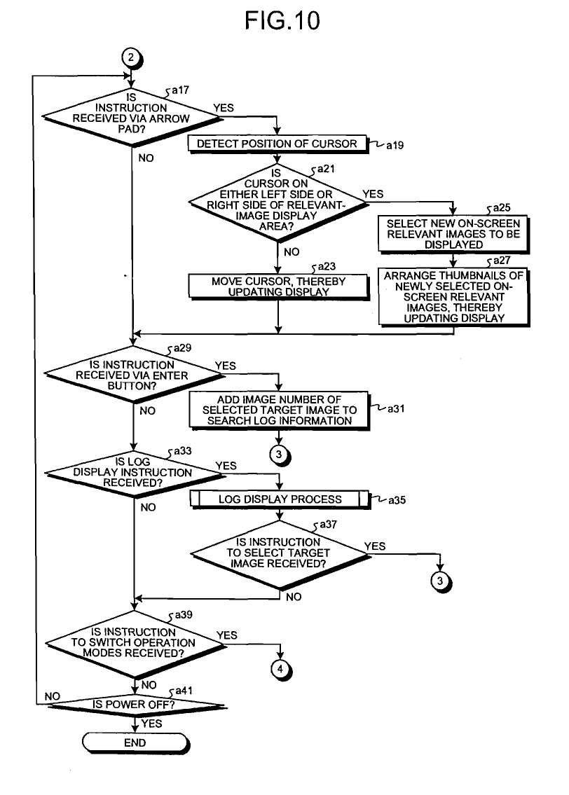

After that, the CPU 27 operates according to user instructions. As shown in FIG. 10, if an instruction is received via the arrow pad 8 (Step a17: Yes), the CPU 27 detects the current position of the cursor in the relevant-image display area (Step a19). If the cursor is on neither the left side nor the right side of the relevant-image display area (Step a21: No), the CPU 27 moves the cursor in the direction specified by the instruction received via the arrow pad 8, thereby updating the display of the relevant-image display area (Step a23).

If the cursor is on either the left side or the right side of the relevant-image display area (Step a21: Yes), the CPU 27 selects a predetermined number of (e.g., five) new images to be displayed from the on-screen relevant images in accordance with the direction specified by the instruction received via the arrow pad 8 (right or left) (Step a25). The CPU 27 arranges the thumbnails of the on-screen relevant images to be displayed, thereby updating the display of the relevant-image display area (Step a27).

If an instruction is received via the enter button 9 (Step a29: Yes), the CPU 27 adds the image number of the on-screen relevant image indicated by the cursor to the target-image log information 293, thereby updating the target-image log information 293 (Step a31). After that, the process control goes to Step a13 of FIG. 8 and the on-screen relevant image setting process is performed with the selected on-screen relevant image being set as the target image.

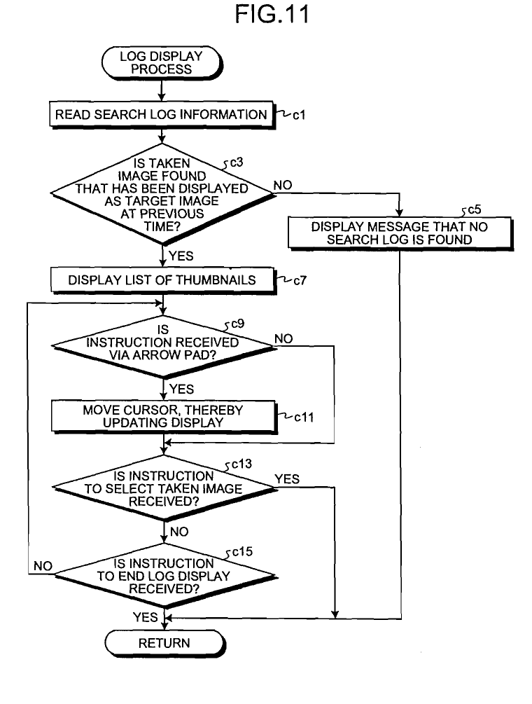

If a log display instruction is received (Step a33: Yes), the CPU 27 performs a log display process (Step a35). It is assumed, for example, the menu button 7 is assigned to the log display function during the search mode. In this case, when an instruction is received via the menu button 7, the process control goes to Step a35. It is noted that some members other than the menu button 7 can be assigned to the log display function. It is allowable to assign the log display function to an additional dedicated member. FIG. 11 is a detailed flowchart of the log display process.

As shown in FIG. 11, during the log display process, the CPU 27 first read the image numbers from the target-image log information 293 (Step c1). If the target-image log information 293 has no image number (the target-image log information 293 is null), i.e., no taken images have been displayed on a screen as the target image (Step c3: No), the CPU 27 displays on the display unit 19 a message that no target-image log is found (Step c5) and the process control returns to Step a35 of FIG. 10 and then goes to Step a37.

If the target-image log information 293 has the image numbers, i.e., one or more taken images have been displayed on a screen as the target image (Step c3: Yes), the CPU 27 displays a list of thumbnails of the taken images corresponding to the read image numbers arranged in chronological search order (Step c7). The cursor is on, for example, the thumbnail of an image having the latest shooting date and time.

After that, if an instruction is received via the arrow pad 8 (Step c9: Yes), the CPU 27 moves the cursor in the direction specified by the instruction received via the arrow pad 8, thereby updating the display (Step c11). The CPU 27 can receive an instruction to select a taken image. If one thumbnail is selected from the list of the thumbnails displayed at Step c7 and the instruction to select the taken image is received (Step c13: Yes), the process control returns to Step a35 of FIG. 10 and then goes to Step a37. If no taken image is selected (Step c13: No), the process control goes to Step c15.

If an instruction to complete the log display process is received (Step c15: Yes), the process control returns to Step a35 of FIG. 10 and then goes to Step a37. If an instruction to complete the log display process has not been received (Step c15: No), the process control returns to Step c9.

At Step a37 of FIG. 10, the CPU 27 determines whether an instruction to select a taken image is received during the log display process. If an instruction to select a taken image is received (Step a37: Yes), the process control goes to Step a13 of FIG. 8 and the CPU 27 performs the on-screen image setting process with the selected image being set as the target image. When the on-screen image setting process is completed, the process control goes to Step a15. If no instruction to select a taken image is received (Step a37: No), the process control goes to Step a39.

At Step a39, the CPU 27 determines whether an instruction to switch between operation modes is received. If the operation mode is switched to a mode other than the search mode, such as the shooting mode and the playback mode (Step a39: Yes), the process control goes to Step a5 of FIG. 8 and the CPU 27 performs the mode process corresponding to the new operation mode. If no instruction to switch between operation modes is received (Step a39: No), the process control goes to Step a41.

At Step a41, the CPU 27 determines whether an instruction to power the digital camera 1 off is received via the power ON/OFF button 6. If an instruction to power the digital camera 1 off is received (Step a41: Yes), the process control goes to end. In this case, the power supply to the units of the digital camera 1 is stopped and the digital camera 1 shifts to the power-off state. If no instruction to power the digital camera 1 off is received (Step a41: No), the process control returns to Step a17 and the CPU 27 waits for a user instruction.

As described above, in the first embodiment, an image having at least one element item identical to the corresponding piece of the element information assigned to the target image is selected from all of the taken images except the target image as a relevant image. Moreover, if there are two or more relevant images that have the combination of the element items identically set, a group of these relevant images is made and one image (e.g., image having the latest shooting date and time) is selected from the group as the representative relevant image. The representative relevant image, the solo relevant image that cannot make a group with another relevant image, and the target image are set as the on-screen relevant images and they are displayed on a screen together with the target image. Therefore, the user can check the images relevant to the target image for search in an efficient manner.

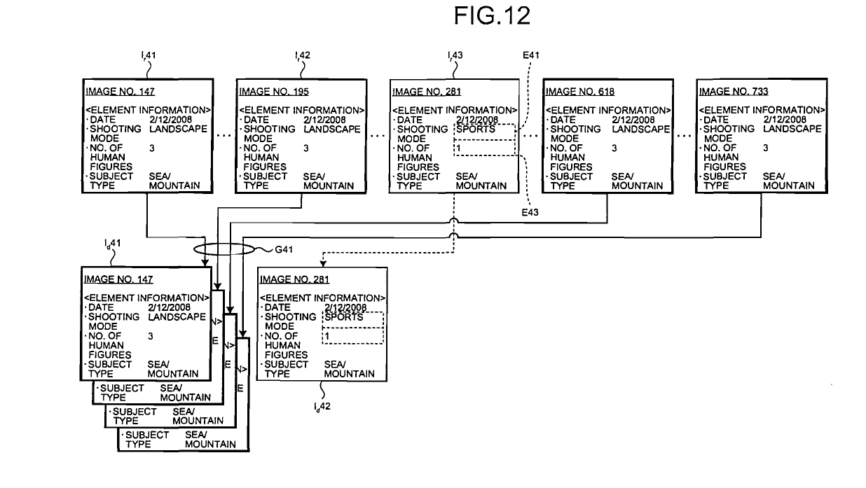

A second embodiment is described below. FIG. 12 is a schematic diagram that explains how images are set as the on-screen relevant images according to the second embodiment. The relevant images shown in FIG. 12 are selected from the taken images stored in the storage unit 20 because they have at least one element item identical to the corresponding piece of the element information assigned to the target image. The relevant images shown in FIG. 12 are the same as those shown in FIG. 7 in the first embodiment that includes the images having the image numbers “147”, “195”, “281”, “618”, and “733”. The element information assigned to these images is shown in FIG. 12.

In the above-described first embodiment, when the target image is selected, images relevant to the target image are selected and on-screen relevant images are then selected. After that, in response to a target-image selecting instruction or an instruction via the arrow pad 8, on-screen relevant images to be displayed are selected from the images that are set as the on-screen relevant images in the above manner. In the second embodiment, in contrast, each time when a target-image selecting instruction or an instruction via the arrow pad 8 is received, on-screen relevant images are selected and the selected on-screen relevant images are displayed. More particularly, during the on-screen relevant image setting process, the taken images are checked in specified sequence and, if the checked image has at least one element item identical to the corresponding piece of the element information assigned to the target image (not shown), the checked image is selected as a relevant image. If the checked image selected as the relevant image has combination of the element items different from the pieces of the element information assigned to any of on-screen relevant images that have already been set as images to be displayed on the updated screen, then the checked image selected as the relevant image is set as an on-screen relevant image. If the checked image set as the relevant image has the combination of the element items identically set, the checked image selected as the relevant image is set as a member of the group that contains the on-screen relevant image having the combination of the element items identically set.

If the on-screen relevant image setting process is performed in response to an instruction to select the target image, the sequence is determined to be according to ascending chronological shooting order and the taken images are checked in sequence according to ascending chronological shooting order. On the other hand, if the on-screen relevant image setting process is performed in response to an instruction received via the arrow pad 8, the sequence is determined depending on the direction specified by the instruction received via the arrow pad 8 (right or left). If, for example, the direction specified by the instruction received via the arrow pad 8 is right, the taken images with their shooting date and time later than the shooting date and time of the on-screen relevant images currently appearing on the relevant-image display area are checked in sequence according to ascending chronological shooting order. If the direction specified by the instruction received via the arrow pad 8 is left, the taken images with their shooting date and time earlier than the shooting date and time of the on-screen relevant images currently appearing on the relevant-image display area are checked in sequence according to descending chronological shooting order.

Suppose there is a situation where, when the element information assigned to the taken images is checked in sequence, the taken image having the image number “147” shown in FIG. 12 is selected as a relevant image Iᵣ41. It is also assumed, in this situation, that no image have been set as an on-screen image to be displayed on the updated screen. In this situation, the relevant image Iᵣ41 is then set as an on-screen relevant image I_{d}41. It is assumed that, after the on-screen relevant image I_{d}41 is set, the taken image having the image number “195” is selected as a relevant image Iᵣ42. The combination of the element items assigned to the relevant image Iᵣ42 is the same as the pieces of the element information assigned to the on-screen relevant image I_{d}41. In this situation, a group G41 that contains both the relevant image Iᵣ42 and the relevant image Iᵣ41 is made.

It is assumed that, after the group G41 is made, the taken image having the image number “281” is selected as a relevant image Iᵣ43. The combination of the element items is compared with the pieces of the element information assigned to the on-screen relevant image I_{d}41. It is then found that element information E41 indicative of the “shooting mode” and element information E43 indicative of the “No. of human figures”, both surrounded by the dotted blocks shown in FIG. 12, are different from the element information assigned to the on-screen relevant image I_{d}41. Therefore, the relevant image Iᵣ43 is set as an on-screen relevant image I_{d}42.

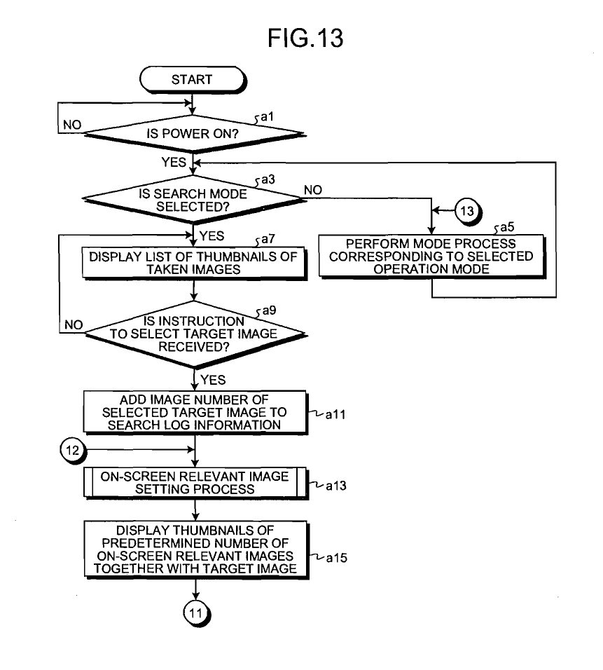

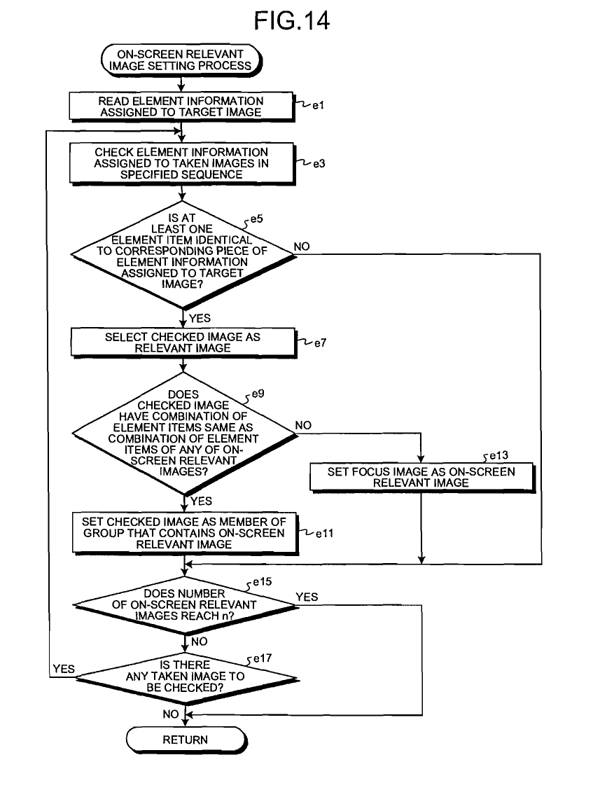

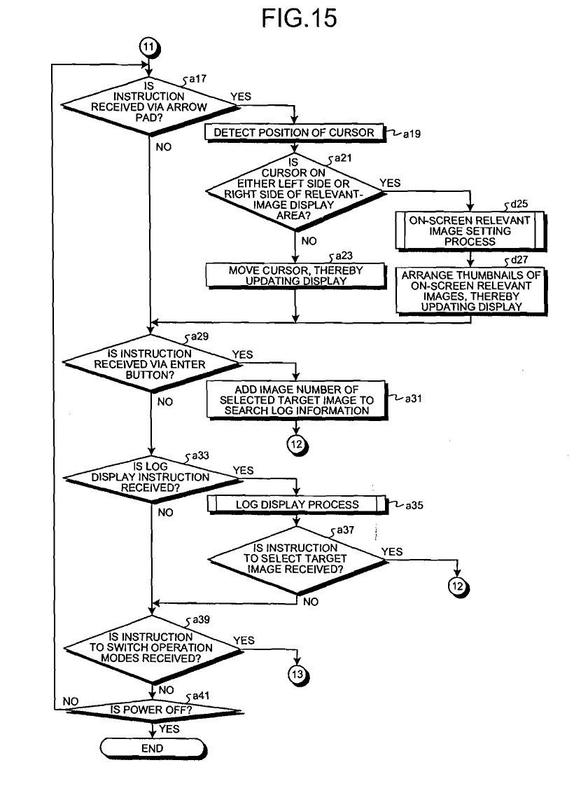

FIG. 13 is a flowchart of a process performed by the digital camera 1 according to the second embodiment. Steps of FIG. 13 corresponding to those in the first embodiment are denoted with the same reference numerals. During the process according to the second embodiment, as shown in FIG. 13, when an instruction to select the target image is received in the search mode (Step a9: Yes), the CPU 27 adds the image number of the selected target image to the target-image log information 293, thereby updating the target-image log information 293 (Step a11). After that, an on-screen relevant image setting process is performed (Step d13). FIG. 14 is a detailed flowchart of an on-screen relevant image setting process according to the second embodiment.

As shown in FIG. 14, during the on-screen relevant image setting process, the CPU 27 first reads the element information assigned to the target image from the element information DB 291 (Step e1). The CPU 27 then checks the taken images with their image data being stored in the storage unit 20 and their element information being stored in the element information DB 291 in specified sequence (Step e3). If the process at Step e3 is performed as a part of Step d13 of FIG. 13 in response to the selecting of the target image, the sequence is determined to be according to ascending chronological shooting order and the taken images are checked in sequence beginning with the image having the earliest shooting date and time. On the other hand, if the process at Step e3 is performed as a part of Step d25 of FIG. 15 in response to an instruction received at Step a17 of FIG. 15 via the arrow pad 8, the taken images are checked in sequence according to the direction (right or left) specified by the instruction received via the arrow pad 8.

The CPU 27 determines, on the basis of the element information assigned to the target image selected at Step e3, whether the checked image has at least one element item identical to the corresponding piece of element information assigned to the target image that has been read at Step e1. If the checked image has no identical element item (Step e5: No), the process control goes to Step e15. If the checked image has an identical element item (Step e5: Yes), the CPU 27 selects the checked image as a relevant image (Step e7).

After that, if the CPU 27 determines that one or more images have already been set as on-screen relevant images to be displayed on the updated screen and the checked image that is selected at Step e7 as the relevant image has the combination of the element items the same as the combination of the element items assigned to any of the on-screen relevant images (Step e9: Yes), the checked image is set as a member of the group that contains the on-screen relevant image having the same combination of the element items (Step e11). The process control then goes to Step e15. If the checked image that is selected as the relevant image has a different combination of the element items (Step e9: No), the CPU 27 sets the checked image as an on-screen relevant image (Step e13) and the process control goes to Step e15.

At Step e15, the CPU 27 determines whether the number of the on-screen relevant images reaches a predetermined number n (e.g., n=5). If the determination is positive (Step e15: Yes), the process control returns to Step d13 of FIG. 13 and then goes to Step d15.

If the determination is negative (Step e15: No), the CPU 27 determines whether there is any taken image to be checked. If taken images are selected in ascending chronological shooting order and the currently checked image is the image having the latest shooting date and time, there is not any more taken image to be checked (Step e17: No); therefore, the process control returns to Step d13 of FIG. 13 and goes to Step a15. If taken images are selected in descending chronological shooting order and the currently checked image is the image having the earliest shooting date and time, there is not any more taken image to be checked (Step e17: No) and the process control returns to Step d13 of FIG. 13 and goes to Step a15. If there is any taken image to be checked (Step e17: Yes), the process control returns to Step e3 and the above processes are repeated to check the taken image.

At Step d15, the CPU 27 displays an updated target-image display screen on the display unit 19 with the target image appearing on the target-image display area at the center and the thumbnails of the updated on-screen relevant images appearing on the relevant-image display area in accordance with the result of the on-screen relevant image setting process at Step d13.

After that, the CPU 27 performs a process corresponding to the user instruction. In the second embodiment, as shown in FIG. 15, when an instruction is received via the arrow pad 8 (Step a17: Yes) and if the cursor is currently on either the left side or the right side of the relevant-image display area (Step a21: Yes), the process control goes to Step d25. At Step d25, the CPU 27 performs the on-screen relevant image setting process by checking images in sequence according to the direction specified by the instruction received via the arrow pad 8. The on-screen relevant image setting process is the same as the process shown in FIG. 14. The CPU 27 arranges the thumbnails of the on-screen relevant images on the relevant-image display area in accordance with the result of the on-screen relevant image setting process performed at Step d25, thereby updating the display of the relevant-image display area (Step d27).

If an instruction is received via the enter button 9 (Step a29: Yes), the CPU 27 adds the image number of the on-screen relevant image indicated by the cursor to the target-image log information 293, thereby updating the target-image log information 293 (Step a31). The process control then goes to Step d13 of FIG. 13 and the on-screen relevant image setting process is performed with the selected on-screen relevant image being set as the target image.

If a log display instruction is received (Step a33: Yes), the CPU 27 performs the log display process (Step a35). If an instruction to select a taken image is received during the log display process performed at Step a35 (Step a37: Yes), the process control goes to Step d13 of FIG. 13 and the CPU 27 performs the on-screen image setting process with the selected image being set as the target image.

As described above, in the second embodiment, when the target image is displayed, an image having at least one element item identical to the element item of the target image is selected as a relevant image. Moreover, if there are two or more relevant images that have the element items each identically set, a group of these relevant images is made and one image is selected from the group for display. Therefore, the same effects that have been obtained in the first embodiment can be obtained.

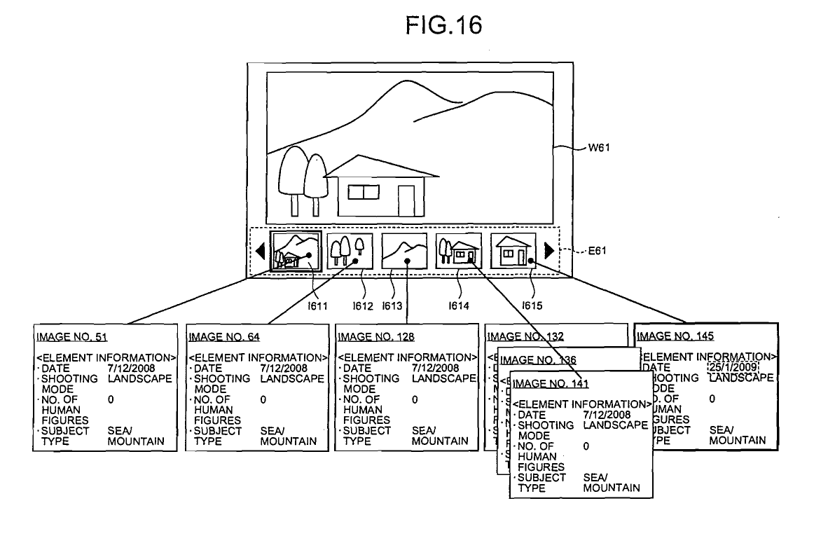

A third embodiment is described below. FIG. 16 is a schematic diagram of a target-image display screen appearing on the display unit 19 when the search mode is selected in the third embodiment. The layout of the target-image display screen is the same as the layout of the target-image display screen according to the first embodiment and the target-image display screen includes a target-image display area W61 and a relevant-image display area E61. FIG. 16 also illustrates the element information assigned to the on-screen relevant images that are displayed on the relevant-image display area E61 in the thumbnail-size images. The on-screen relevant images correspond to thumbnails I611 to I615.

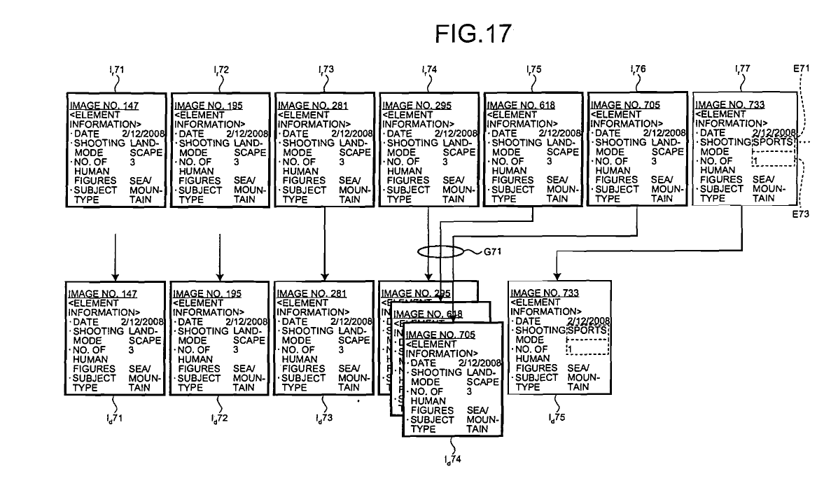

FIG. 17 is a schematic diagram that explains how images are set as the on-screen relevant images according to the third embodiment. Relevant images Iᵣ71 to Iᵣ77 shown in FIG. 17 are selected from the taken images stored in the storage unit 20 (because they have at least one element item identical to the corresponding piece of the element information assigned to the target image).

In the third embodiment, when the on-screen relevant image setting process is performed in response to an instruction to select the target image or an instruction received via the arrow pad 8, successive n number of (e.g., n=5) relevant images are extracted from the relevant images arranged in specified sequence. If all the extracted relevant images have the combination of the element items identically set, the CPU 27 searches for an image that has the combination of the element items differently set amongst the relevant images after the last-extracted relevant image (n-th image: the fifth image on the right side shown in FIG. 17). If the on-screen relevant image setting process is performed in response to an instruction to select the target image, the sequence is determined to be according to ascending chronological shooting order in the same manner as in the second embodiment. On the other hand, if the on-screen relevant image setting process is performed in response to an instruction received via the arrow pad 8, the sequence is determined depending on the direction specified by the instruction received via the arrow pad 8 (right or left). If the direction specified by the instruction received via the arrow pad 8 is right, the sequence is determined to be according to ascending chronological shooting order. If the direction specified by the instruction received via the arrow pad 8 is left, the sequence is determined to be according to descending chronological shooting order.

Suppose for example there is the situation shown in FIG. 17 where the relevant images Iᵣ71 to Iᵣ75 are extracted from the selected relevant images Iᵣ71 to Iᵣ77 as the extracted relevant images. All the relevant images Iᵣ71 to Iᵣ75 have the combination of the element items identically set. Therefore, the CPU 27 checks the element information assigned to the relevant images after the last-extracted relevant image Iᵣ75 in sequence beginning with the relevant images Iᵣ76 followed by the relevant image Iᵣ77 and the subsequent relevant images. The CPU 27 first checks the element information assigned to the relevant images Iᵣ76 immediately after the relevant images Iᵣ75 and compares it with the element information assigned to the relevant images Iᵣ71 to Iᵣ75. The combination of the element items assigned to the relevant images Iᵣ76 is the same as the combination of the element items assigned to the relevant images Iᵣ71 to Iᵣ75. Therefore, the CPU 27 then checks the relevant images Iᵣ77 immediately after the relevant images Iᵣ76. The relevant image Iᵣ76 has element information E71 indicative of the “shooting mode” and element information E73 indicative of the “No. of human figures” different from the respective pieces of the element information assigned to the relevant images Iᵣ71 to Iᵣ75. As a result, the relevant images Iᵣ77 is found.

When the relevant images Iᵣ77 that has combination of the element items different from the combination of the element items assigned to the extracted relevant images is found, the first to the third extracted relevant images Iᵣ71 to Iᵣ73 are set as on-screen relevant images I_{d}71 to I_{d}73. Moreover, the successive images from the fifth (n-th) extracted relevant image to the relevant image immediately before the search position (in the example shown in FIG. 17, the relevant images Iᵣ75 and Iᵣ76) are set as members of a group G71 that contains the relevant image Iᵣ74 and an image having, for example, the latest shooting date and time is selected from the group G71 as an on-screen relevant image I_{d}74. The relevant image Iᵣ77 on the search position is set as an on-screen relevant image I_{d}75.

Data containing the images that are set as the on-screen relevant images in this manner is display on the relevant-image display area of the target-image display screen in the thumbnail-size images. As shown in FIG. 16, the on-screen relevant images corresponding to four thumbnails on the left, i.e., the thumbnails I611 to I614 have the combination of the element items identically set. In contrast, the on-screen relevant image corresponding to the right-most thumbnail I615 has combination of the element items different from the pieces of the element information assigned to the four thumbnails I611 to I614. In other words, in the third embodiment, as for thumbnails of the on-screen relevant images appearing on the relevant-image display area E61, the maximum number of on-screen relevant images that have the combination of the element items identically set is four. At least one of the on-screen relevant images has combination of the element items different from the combination of the element items assigned to the other on-screen relevant images.

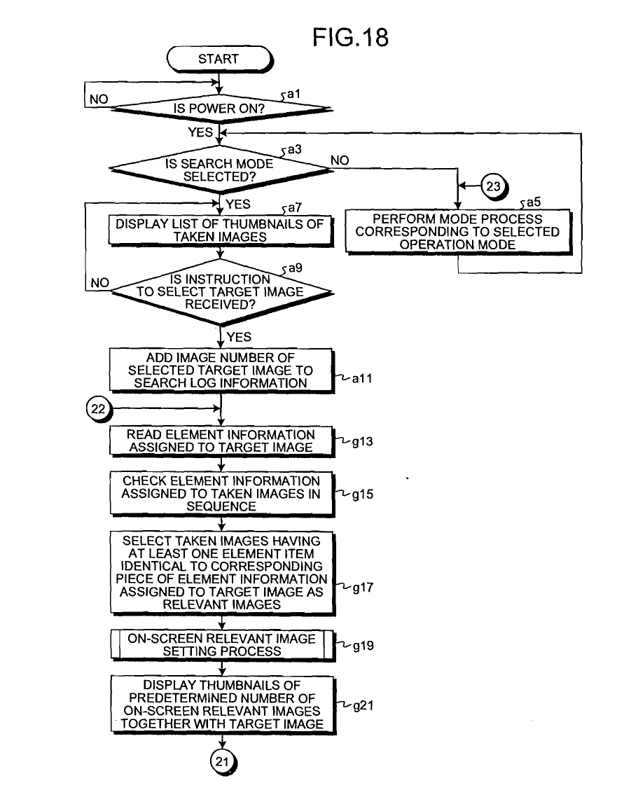

FIG. 18 is a flowchart of a process performed by the digital camera 1 according to the third embodiment. Steps of FIG. 18 corresponding to those in the first embodiment are denoted with the same reference numerals. During the process according to the third embodiment, as shown in FIG. 18, when an instruction to select the target image is received in the search mode (Step a9: Yes), the CPU 27 adds the image number of the selected target image to the target-image log information 293, thereby updating the target-image log information 293 (Step a11). After that, the element information assigned to the target image is read from the element information DB 291 (Step g13).

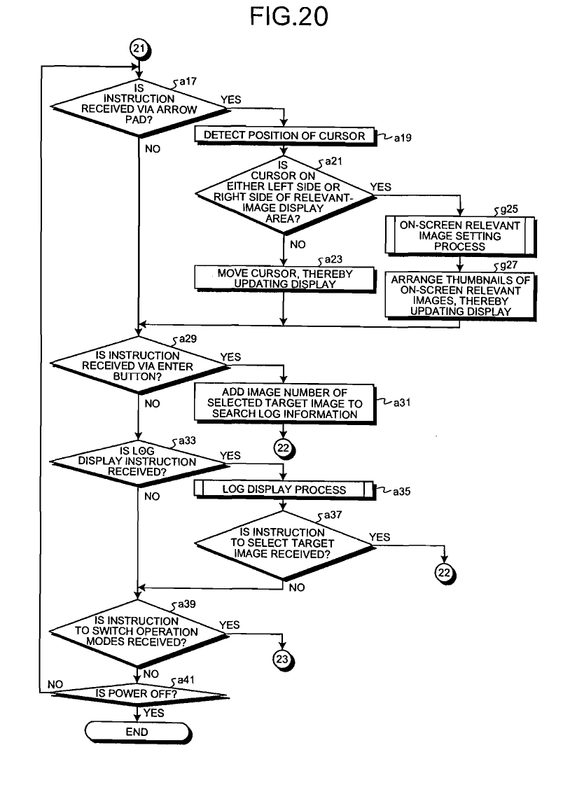

After that, the CPU 27 checks every taken image with their image data being stored in the storage unit 20 and their element information being stored in the element information DB 291 in specified sequence (Step g15). The CPU 27 selects taken images having at least one element item identical to the corresponding piece of the element information assigned to the target image read at Step g13 as relevant images (Step g17). If the process at Step g15 is performed in response to the selecting of the target image, the taken images are checked in sequence according to ascending chronological shooting order. On the other hand, if the process at Step g15 is performed in response to a later-described instruction received via the arrow pad 8 at Step a17 of FIG. 20, the taken images are checked in sequence according to the direction (right or left) specified by the instruction received via the arrow pad 8.

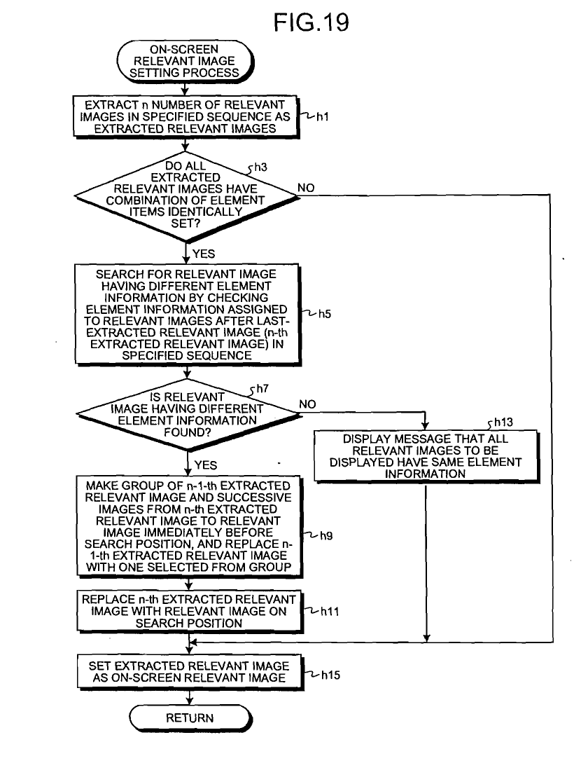

After that, the CPU 27 performs an on-screen relevant image setting process (Step g19). FIG. 19 is a detailed flowchart of the on-screen relevant image setting process according to the third embodiment. As shown in FIG. 19, during the on-screen relevant image setting process, the CPU 27 first extracts n number of (e.g., n=5) successive relevant images from the relevant images arranged in specified sequence (Step h1). More particularly, if the on-screen relevant image setting process is performed in response to an instruction to select the target image, n number of successive relevant images is extracted from the relevant images arranged in ascending chronological shooting order (Step h1). On the other hand, if the on-screen relevant image setting process is performed in response to an instruction received via the arrow pad 8, n number of successive relevant images is extracted from the relevant images arranged in sequence according to the direction (right or left) specified by the instruction received via the arrow pad 8. If the specified sequence is in ascending chronological shooting order, the CPU 27 extracts the relevant images with their shooting date and time later than the shooting date and time of the on-screen relevant images currently appearing on the relevant-image display area. On the other hand, if the specified sequence is in descending chronological shooting order, the CPU 27 extracts the relevant images with their shooting date and time earlier than the shooting date and time of the on-screen relevant images currently appearing on the relevant-image display area.

After that, the CPU 27 determines whether all the extracted relevant images have combination of the element items identically set. If one or more of the extracted relevant images have combination of the element items differently set (Step h3: No), the process control goes to Step h15 and the CPU 27 sets the extracted relevant images that are extracted at Step h1 as the on-screen relevant images. After that, the process control returns to Step g19 of FIG. 18 and goes to Step g21.

If all the extracted relevant images have combination of the element items identically set (i.e., every element item is identically set) (Step h3: Yes), the CPU 27 checks the element information assigned to the relevant images after the last-extracted relevant image (n-th extracted relevant image) in sequence and searches for a relevant image having combination of the element items different from the combination of the element items assigned to the extracted relevant images (Step h5). If such an image is found (Step h7: Yes), the CPU 27 makes a group of the n−1-th extracted relevant image and successive images from the n-th extracted relevant image to the relevant image immediately before the search position and replaces the n−1-th extracted relevant image with, for example, an image having the latest shooting date and time selected from the group (Step h9). After that, the CPU 27 replaces the n-th extracted relevant image with the relevant image on the search position (Step h11).

After that, the process control goes to Step h15 and the CPU 27 sets the extracted relevant images that include the new n−1-th and the new n-th extracted relevant images as the on-screen relevant images. The process control then returns to Step g19 of FIG. 18 and goes to Step g21.

If an image having different element information is not found (Step h7: No), a message is displayed on the display unit 19 that all the relevant images to be displayed (on-screen relevant images) have the same element information (Step h13). After that, the process control goes to Step h15 and the extracted relevant images that are extracted at Step h1 are set as the on-screen relevant images. The process control then returns to Step g19 of FIG. 18 and goes to Step g21.

At Step g21, the CPU 27 displays the target-image display screen shown in FIG. 16 on the display unit 19 with the target image appearing at the center and the thumbnails of the updated on-screen relevant images appearing on the relevant-image display area in accordance with the result of the on-screen relevant image setting process at Step g19.

After that, the CPU 27 performs a process corresponding to the user instruction. In the third embodiment, as shown in FIG. 20, when an instruction is received via the arrow pad 8 (Step a17: Yes) and if the cursor is currently on either the left side or the right side of the relevant-image display area (Step a21: Yes), the process control goes to Step g25. At Step g25, the CPU 27 performs the on-screen relevant image setting process by checking images in sequence according to the direction specified by the instruction received via the arrow pad 8. The on-screen relevant image setting process is the same as the process shown in FIG. 19. The CPU 27 arranges the thumbnails of the on-screen relevant images on the relevant-image display area in accordance with the result of the on-screen relevant image setting process performed at Step g25, thereby updating the display of the relevant-image display area (Step g27).

If an instruction is received via the enter button 9 (Step a29: Yes), the CPU 27 adds the image number of the on-screen relevant image indicated by the cursor to the target-image log information 293, thereby updating the target-image log information 293 (Step a31). The process control then goes to Step g13 of FIG. 18 and the on-screen relevant image setting process is performed with the selected on-screen relevant image being set as the target image.

If a log display instruction is received (Step a33: Yes), the CPU 27 performs the log display process (Step a35). If an instruction to select a taken image is received during the log display process performed at Step a35 (Step a37: Yes), the process control goes to Step g13 of FIG. 18 and the CPU 27 performs the on-screen image setting process with the selected image being set as the target image.

As described above, in the third embodiment, when the target image is displayed, images each having at least one element item identical to the element item of the target image is selected as relevant images. Even if the successive relevant images have the combination of the element items identically set, images appearing on the relevant-image display area of the target-image display screen include at least one relevant image having combination of the element items differently set. Therefore, the same effects that have been obtained in the first embodiment can be obtained.

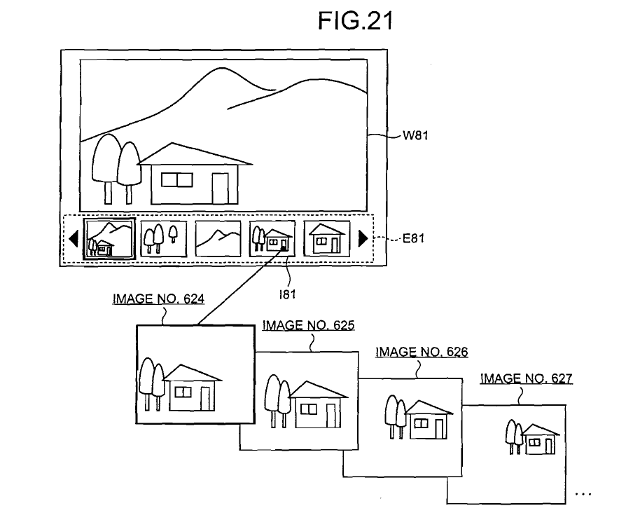

A fourth embodiment is described below. FIG. 21 is a schematic diagram of a target-image display screen appearing on the display unit 19 when the search mode is selected in the fourth embodiment. The layout of the target-image display screen is the same as the layout of the target-image display screen according to the first embodiment and the target-image display screen includes a target-image display area W81 and a relevant-image display area E81. FIG. 21 also illustrates relevant images having the image numbers “625”, “626”, and “627” that are hidden because they are set as members of the group that contains an on-screen relevant image having the image number “624” appearing on the relevant-image display area E81 as a thumbnail I81.

In the fourth embodiment, serial numbers are assigned to individual continuous shooting images taken in the continuous shooting mode and, therefore, the continuous shooting images are identifiable. If a continuous shooting image with a serial number is selected as a relevant image, a group of the continuous shooting images is made and one image (e.g., the image having the earliest date and time) is selected as the representative relevant image from the continuous shooting images. In the example shown in FIG. 21, from the four continuous shooting images having the image numbers “624”, “625”, “626”, and “627”, the continuous shooting image having the image number “624” is selected as the representative relevant image.

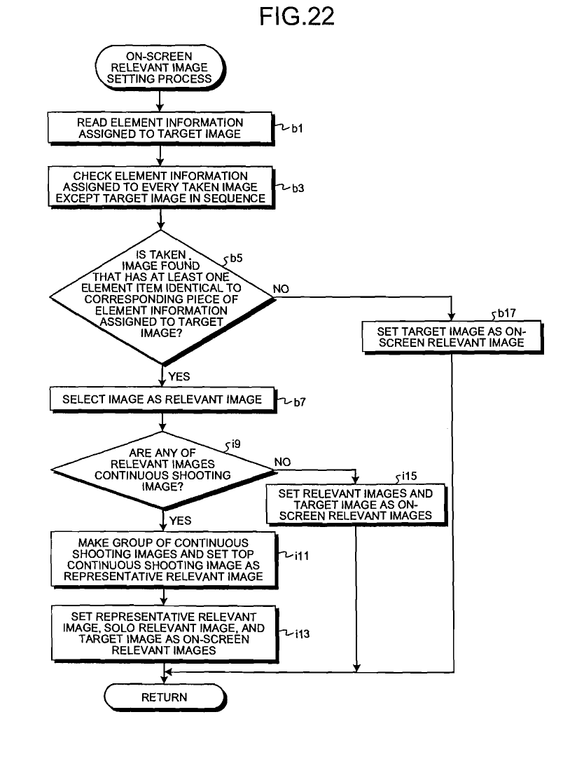

In this case, an on-screen relevant image setting process shown in FIG. 22 is performed instead of the on-screen relevant image setting process at Step a13 of FIG. 8 in the first embodiment. Steps of FIG. 22 corresponding to those in the first embodiment are denoted with the same reference numerals.

During the on-screen relevant image setting process according to the fourth embodiment, after the CPU 27 selects, as shown in FIG. 22, the relevant images at Step b7, the CPU 27 determines whether any of the relevant images are a continuous shooting image. If any of the relevant images are a continuous shooting image (Step i9: Yes), the CPU 27 makes a group of the continuous shooting images and sets, for example, the top continuous shooting image as the representative relevant image (Step i11). The CPU 27 sets the representative relevant image, the solo relevant image that cannot make a group with another image, and the target image as the on-screen relevant images (Step i13).

On the other hand, if it is determined at Step i9 that no relevant image is a continuous shooting image, the CPU 27 sets the relevant images selected at Step b7 and the target image as the on-screen relevant images (Step i15).

As described above, in the fourth embodiment, when the target image is displayed, images each having at least one element item identical to the element item of the target image are selected as relevant images. If any of the relevant images are a continuous shooting image, a group of the continuous shooting images is made and one image (e.g., the image having the earliest date and time) is selected as the representative image from the group. Therefore, the same effects that have been obtained in the first embodiment can be obtained.

In the above-described fourth embodiment, a group that contains a set of the four continuous shooting images that is taken in the continuous shooting mode is made, and one image is selected as the representative image from the group. In contrast, it is allowable to determine, on the basis of information about the shooting date and time, images taken at intervals a predetermined time (e.g., three seconds) or shorter to be a set of continuous shooting images and make a group of the continuous shooting images. One image is selected as the representative image from the group.

Although, in the above-described embodiments, the element items include the “shooting date”, the “shooting mode”, the “No. of human figures”, and the “subject type”, the types and the number of the element items can be changed appropriately.

For example, it is allowable to extract information about types of events, such as the sports festival, the birthday, and the Christmas day, from the image data in accordance with a result of image processing or the shooting date and time or the like and set the types of events as the element information. It is also allowable to estimate, using a well-known image recognition process, the sex, the facial expression, and the age of the human figure detected in the image data and set the extracted data as the element information. It is also allowable to register the face of a predetermined human figure, identify, using a well-known image recognition process, the human figure in the image data on the basis of the registered face, and set the identified human figure as the element information. It is also allowable to measure a degree of brightness (bright or dark) or the hue of each image on the basis of its pixel values, recognize the mood of each image, and set the mood as the element information.

It is allowable to design types of element items selectable according to, for example, a user instruction. When an instruction to select an element item is received from the user, information corresponding to the selected element item is extracted from each image stored in the storage unit 20 and the extracted information is set as the element information.

In the above-described embodiments, some relevant images are selected as on-screen relevant images by checking the relevant images in sequence according to chronological order (chronological shooting order) and the on-screen relevant images are displayed on the relevant-image display area. However, it is also allowable to select a piece of important element information in accordance with, for example, a user instruction and check taken images in sequence beginning with images having the pieces of important element information. In this case, the CPU 27 works as an importance setting unit, i.e., sets a piece of element information as important element information in accordance with, for example, a user instruction, and stores the important element information in the flash ROM 29. It is assumed, for example, that the “portrait mode” of the element item “shooting mode” is set as the important element information. In this case, the CPU 27 checks the relevant images in sequence beginning with taken images each having the shooting mode “portrait mode”. It is assumed another example in which the mood of each image is set as a piece of element information in the same manner as in the above-described modification and “bright” is set as the important element information. In this case, the CPU 27 checks the relevant images in sequence beginning with taken images having “bright” as the element information. If some relevant images are selected as on-screen relevant images by checking the relevant images in sequence according to chronological order in the same manner as in the above-described embodiments, the time taken to view an image in the back with respect to chronological order may increase. In contrast, if the present modification is taken, because a piece of element information can be set appropriately as important element information, the user can search for images relevant to the target image in an efficient manner.

The present invention is not limited to the embodiments described above. Another embodiment can be formed by combining some components appropriately selected from the plurality of components disclosed in the embodiments. For example, one embodiment can be formed by eliminating some from all the components disclosed in an embodiment above described. Another embodiment can be formed by combining components appropriately selected from components of different embodiments.

Although, in the above-described embodiments, the digital camera is used as the image search device according to the present invention, some other devices can be used as the image search device, such as a camera cell-phone, a music player, a recording device, and a laptop personal computer. Moreover, the above-described technology can be used in an image search device that does not include the imaging unit 100 (camera), such as a personal computer that stores therein images and element information assigned to the images (element information DB).

According to the present invention, a predetermined number of images each having at least one piece of element information identical to the corresponding piece of element information assigned to a target image is selected as relevant images in such a manner that the relevant images include at least one relevant image has combination of pieces of the element information different from the combination of pieces of the element information assigned to the other relevant images. This brings an efficient search for images relevant to the target image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image search device comprising:
an image storage unit that stores therein a plurality of pieces of image data;
an element-information storage unit that stores therein a plurality of pieces of element information indicative of element items assigned respectively to the pieces of the image data stored in the image storage unit;
a target-image selecting unit that selects target image data from the image data stored in the image storage unit;
a target-image displaying unit that displays the target image data selected by the target-image selecting unit on a display unit;
a relevant-image selecting unit that selects a predetermined number of pieces of relevant image data that contain at least one of the pieces of element information identical to the piece of element information assigned to the target image data in such a manner that the predetermined number of pieces of relevant image data contain at least one image that has a different combination of the pieces of element information; and
a relevant-image displaying unit that displays, on the display unit, the predetermined number of pieces of relevant image data selected by the relevant-image selecting unit.

2. The image search device according to claim 1, wherein the relevant-image selecting unit selects, from pieces of image data having at least one of the pieces of element information identical to the piece of element information assigned to the target image data, the predetermined number of pieces of relevant image data in such a manner that the predetermined number of pieces of relevant image data do not contain any more than a predetermined number of pieces of image data that have a same combination of the pieces of element information.

3. The image search device according to claim 2, wherein
the relevant-image selecting unit selects a predetermined number of pieces of relevant image data having at least one of the pieces of element information identical to the piece of element information assigned to the target image data, and
if all the selected predetermined number of pieces of relevant image data have a same combination of the pieces of element information, the relevant-image selecting unit replaces at least one of the predetermined number of pieces of relevant image data with another piece of relevant image data that has a different combination of pieces of the element information from that of the selected predetermined number of pieces of relevant image data.

4. The image search device according to claim 1, wherein
the relevant-image selecting unit makes a same group of pieces of image data that have a same combination of pieces of the element information, from pieces of image data having at least one of the pieces of element information identical to the piece of element information assigned to the target image data, and
the relevant-image selecting unit selects, as a pieces of the relevant image data, one of the pieces of image data belonging to the same group.

5. The image search device according to claim 1, wherein the relevant-image displaying unit displays on the display unit both the target image data and the predetermined number of pieces of relevant image data.

6. The image search device according to claim 1, wherein, in response to selection of one of the pieces of relevant image data that are displayed on the display unit by the relevant-image displaying unit, the target-image selecting unit selects the selected piece of relevant image data as new target image data.

7. The image search device according to claim 1, further comprising an importance setting unit that sets a degree of importance of the pieces of element information for each element item, wherein
the relevant-image selecting unit selects the predetermined number of pieces of relevant image data in sequence beginning with pieces of image data that contain element information having a high degree of importance in accordance with the setting performed by the importance setting unit, from the pieces of image data stored in the image storage unit.

8. The image search device according to claim 1, wherein
the relevant-image displaying unit displays the predetermined number of pieces of relevant image data in a row,
the image search device further comprises an operation unit that is used to put a piece of relevant image data in a selected state in such a manner that the selected state is switched from a piece of relevant image data to another piece of relevant image data adjacent to the piece of relevant image data, wherein
the target-image selecting unit selects, as new target image data, the piece of relevant image data in the selected state when an instruction to select the relevant image data is received.

9. The image search device according to claim 1, further comprising:
a target-image log storage unit that stores therein logs of image data selected as the target image data by the target-image selecting unit at a previous time;
a target-image log displaying unit that displays on the display unit, on the basis of the logs stored in the target-image log storage unit, the image data selected as the target image data at a previous time; and
a switching unit that switches between a screen of the target image data displayed by the target-image displaying unit and a screen of the image data selected as the target image data at a previous time and displayed by the target-image log displaying unit.

10. An image search method comprising:
selecting target image data from image data stored;
displaying the selected target image data;
selecting, on the basis of a plurality of pieces of element information indicative of element items assigned respectively to the pieces of the image data, a predetermined number of pieces of relevant image data that contain at least one of the pieces of element information identical to the piece of element information assigned to the target image data in such a manner that the predetermined number of pieces of relevant image data contain at least one image that has a different combination of the pieces of element information; and
displaying the predetermined number of pieces of relevant image data selected.
